(19) United States
(12) Patent Application Publication
(10) Pub. No.: US 2026/0138857 A1
(43) Pub. Date: May 21, 2026

(54) OIL RELEASE MECHANISM FOR LIGHTWEIGHT JACK

(71) Applicant: Hangzhou Tianheng Machinery Co., Ltd., Hangzhou (CN)

(72) Inventors: Zhengwei GONG, Hangzhou (CN); Haoliang ZHOU, Hangzhou (CN); Dongfang ZHOU, Hangzhou (CN)

(21) Appl. No.: 19/202,585

(22) Filed: May 8, 2025

(30) Foreign Application Priority Data
Nov. 21, 2024 (CN) 202422849028.4

(51) Int. Cl. B66F 3/42; F15B 21/00

(52) U.S. Cl. CPC B66F 3/42; F15B 21/005

(57) ABSTRACT

Provided is an improved oil release mechanism for a lightweight jack, which is matched with an oil pump body. The pump body is equipped with a valve chamber, an moving chamber, an oil storage chamber, and an oil return passage. The valve chamber is located in the middle of the oil return passage and is connected to the oil storage chamber and the moving chamber at both ends. The main body of the oil pump is hinged with a pump lever, which includes a drain valve located in the valve chamber and having a driving part, a rotation shaft located in the pump lever chamber and positioned for rotation, and a transmission component for transmitting the power of the rotation shaft to drive the opening and closing of the drain valve. The present disclosure can effectively simplify the operation process and conveniently achieve pressure relief operation.

### CROSS-REFERENCE TO RELATED APPLICATIONS

This application claims priority to Chinese Application No. CN202422849028.4, filed on Nov. 21, 2024, entitled “IMPROVED OIL RELEASE MECHANISM FOR LIGHTWEIGHT JACK”. These contents are hereby incorporated by reference.

### TECHNICAL FIELD

The present disclosure relates to the technical field of lifting tools, in particular to an improved oil release mechanism for a lightweight jack.

### BACKGROUND

When using a jack, it is necessary to first connect the handle to the pump lever, and then operate the handle to drive the oil pump core to move back and forth through the pump lever, in order to lift heavy objects. When unloading pressure is required to complete the lifting task, open the oil drain valve on the jack, and the oil return passage will be connected. Under the action of oil pressure, the jack can be smoothly reset. In current, the oil release mechanism used in lightweight jacks mainly includes the following structures:
The first, during the pressure relief and oil release operation, it is necessary to first separate the handle and the pump lever from each other, and then use the handle to rotate the oil drain valve to complete the pressure relief operation. The overall process is quite cumbersome and inconvenient;
The second, as shown in FIG. 5, the connection between the pump lever and the oil drain valve is achieved through a set of (usually two) gears. During the pressure relief and oil release operation, the operator only needs to directly rotate the handle to easily open the oil drain valve without disassembling the handle throughout the process. However, in the above structure, one of the gears is installed on the pump lever and will swing with the pump lever during operation, while the other gear is installed on the main body of the oil pump, and the two are always in a dynamic meshing state. Due to the machining accuracy of the gears and the wear caused by long-term and frequent use, it is easy to cause poor gear meshing, which has a negative impact on the service life of the gears;
Thirdly, as shown in FIG. 6, a universal joint is used to connect the pump lever and the oil drain valve. This connection method makes the overall structure more stable. During the pressure relief and oil release operation, the operator can easily open the oil drain valve by simply turning the handle. However, in the above structure, the pump lever is hinged on the wall panel and located on the right side of the main body of the oil pump. This layout requires an increase in the size of the wall panel, which leads to an overall increase in the volume of the jack. This not only occupies more space, but also increases the cost of the product.

### SUMMARY

The disclosure provides an improved oil release mechanism for a lightweight jack to at least solve the problems of cumbersome and inconvenient pressure relief operations, poor meshing caused by dynamic meshing of gears during long-term use, and overall volume increase in existing technology for lightweight jacks.

First, the present disclosure provides an improved oil release mechanism for a lightweight jack, which includes an oil pump body, wherein the oil pump body is provided with at least one valve chamber, one moving chamber, one oil storage chamber, and one oil return passage; the valve chamber is located in a middle of the oil return passage and is connected to the oil return passage; two ends of the oil return passage are respectively connected to the oil storage chamber and the moving chamber; and a main body of the oil pump is hinged with a pump lever; and the improved oil release mechanism further includes:
An oil drain valve, set inside the valve chamber and provided with a driving part extending to an outside of the valve chamber;
A rotation shaft, axially set in an inner chamber of the pump lever and positioned with the pump lever for rotation; and
A transmission component, configured to transmit power of the rotation shaft to drive an opening and closing of the oil drain valve, wherein the transmission component includes a first gear rotatably assembled on a base formed on one side of the oil pump body; an universal joint, with its two ends respectively connected to the first gear and a first end of the rotation shaft; and a second gear coaxially arranged with the driving part and meshed with the first gear.

Optionally, an angle is formed between a rotation axis of the first gear and a rotation axis of the second gear, and a range of the angle is 45°-60°.

Optionally, the universal joint is a cross universal joint, and a center of the universal joint is located on a rotation axis of the pump lever.

Optionally, the universal joint includes:
A first fork, coaxially fixed and assembled with the rotation shaft;
A second fork, coaxially fixed and assembled with the first gear; and
A cross shaft, set between the first fork and the second fork to relay a transmission of the first fork and the second fork.

Optionally, the oil drain valve includes:
A driving part, including a first end coaxially fixed and assembled with the second gear, and a second end axially positioned in the valve chamber and rotatably assembled with an inner chamber of the valve chamber;
A valve stem, including a first stem portion and a second stem portion, wherein the first stem portion is threaded to an inner wall of the valve chamber, and the second stem portion extends to the outside of the valve chamber and is axially movable connected to a second end of the driving part; and
A steel ball, movably set within the valve chamber and located at a free end of the first stem portion, wherein a diameter of the steel ball is greater than a diameter of the oil return passage to block the oil return passage when the steel ball pushed against by the valve stem.

Optionally, a section of a free end of the second stem portion is a non-circular structure, and a second end of the driving part is axially provided with a non-circular positioning hole that matches the second stem portion.

Optionally, the handle is provided with a insertion portion assembled with a free end of the pump lever, and a free end of the insertion portion is provided with a rotary mating groove, and a second end of the rotation shaft is formed with a rotary mating head that matches the rotary mating groove.

Optionally, at least one locking bolt is threaded at a position corresponding to the plug-in portion of the pump lever, and a tail of the locking bolt extends into the annular groove opened on the plug-in portion to lock an assembly of the pump lever and handle.

Advantageous effects of the present disclosure are shown as below:
1. When using the lightweight jack provided by the present disclosure, the user only needs to rotate the handle, and its power is transmitted through the universal joint and driven by the meshing of the first gear and the second gear, driving the valve stem of the oil drain valve to rotate, easily achieving pressure relief operation. The entire process does not require separating the handle from the pump lever, greatly simplifying the operation process and providing a good user experience.
2. The pump lever in this disclosure is hinged on the main body of the oil pump, without the need for wall panels, making the structure more compact and reducing the overall volume of the lightweight jack. This not only reduces production costs, but also enhances the portability of the lightweight jack product, especially suitable for loading in the trunk of a car, providing emergency support for the car.
3. When using the product provided by the present disclosure, the swing of the pump lever will not drive the movement of the first gear and the second gear, eliminating the dynamic meshing state of the first gear and the second gear. The stable structure ensures the reliability of product operation and significantly extends its service life.

### BRIEF DESCRIPTION OF THE DRAWINGS

FIG. 1 is a sectional view of a lightweight jack structure according to an exemplary embodiment.

FIG. 2 is the first sectional view of an improved oil release mechanism according to an exemplary embodiment.

FIG. 3 is the second sectional view of the improved oil release mechanism according to an exemplary embodiment.

FIG. 4 is a structural schematic diagram of the combination of the oil drain valve and the first gear according to an exemplary embodiment.

FIG. 5 is the first structural schematic diagrams of the prior art.

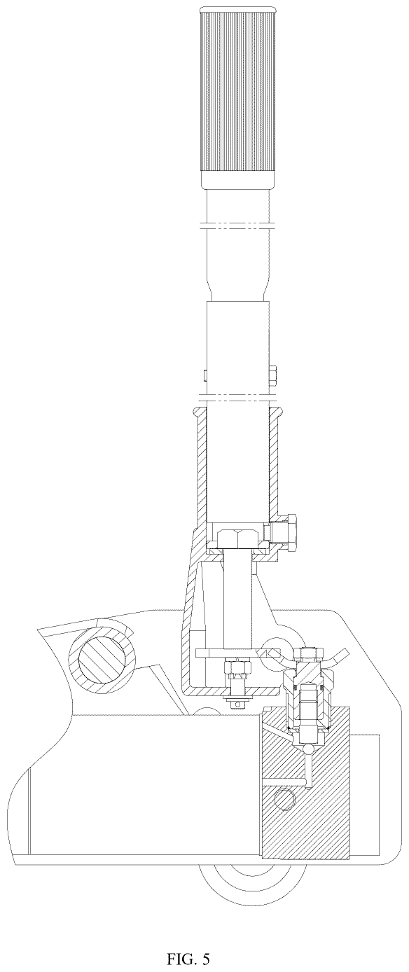

FIG. 6 is the second structural schematic diagrams of the prior art.

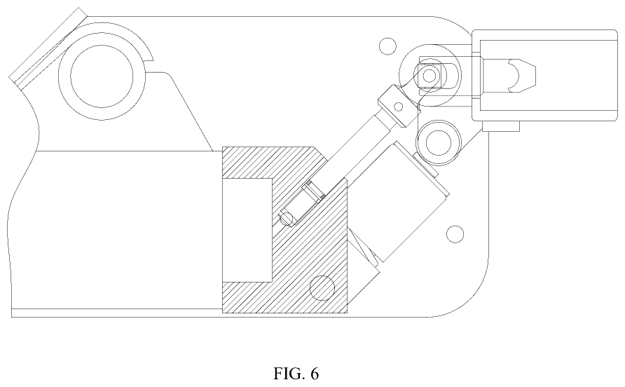

Reference numbers in the drawings:
Oil pump body 1; valve chamber 101; moving chamber 102; oil storage chamber 103; oil return passage 104; one-way valve 105; oil cylinder chamber 106; oil inlet passage 107; lifting component 108; oil pump core 109;
Pump lever 2; oil drain valve 3; driving part 301; positioning hole 3011; valve stem 302; first stem portion 3021; second stem portion 3022; steel ball 303; rotation shaft 4;
Transmission component 5; first gear 501; universal joint 502; first joint fork 521; second joint fork 522; cross shaft 523; second gear 503;
Locking bolt 6; handle 7; insertion portion 701; rotary mating groove 702; annular groove 703.

### DETAILED DESCRIPTION OF THE EMBODIMENT

### Embodiment 1

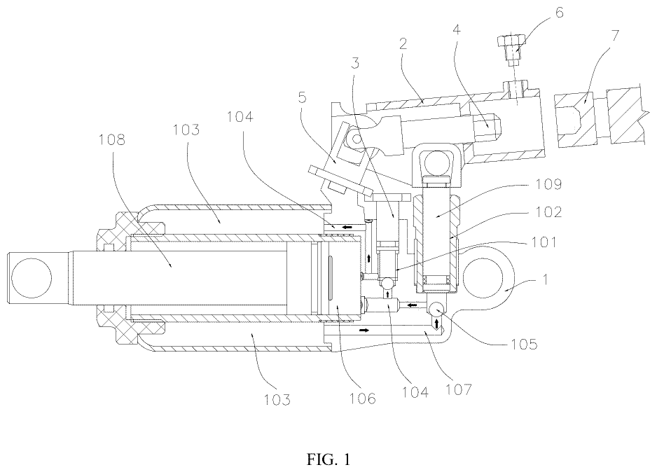

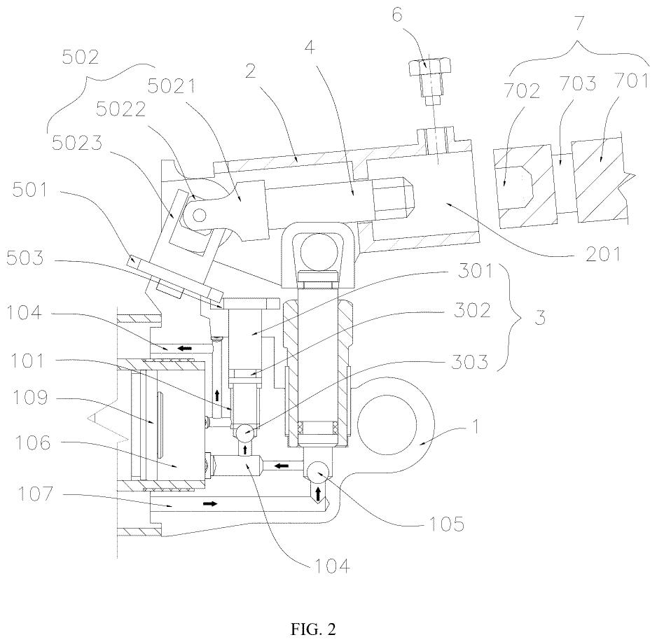

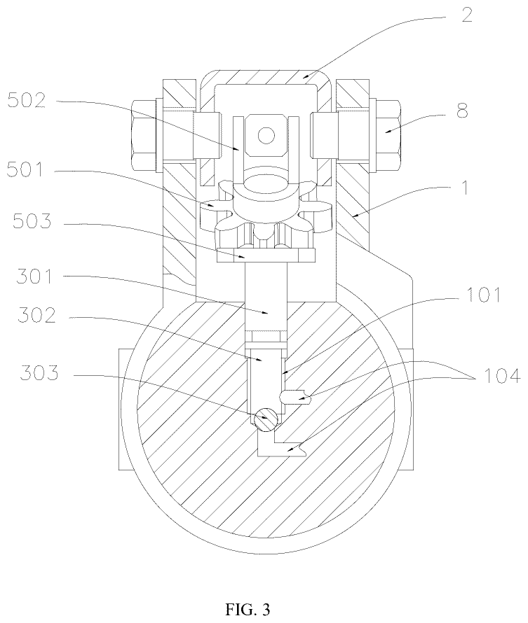

The embodiment of the present disclosure provides an improved oil release mechanism for a lightweight jack. FIG. 1 is a sectional view of a lightweight jack structure according to an exemplary embodiment. FIG. 2 is the first sectional view of an improved oil release mechanism according to an exemplary embodiment. FIG. 3 is the second sectional view of an improved oil release mechanism according to an exemplary embodiment. As shown in FIG. 1-FIG. 3, the improved oil release mechanism includes an oil pump body 1. The oil pump body 1 is provided with at least one valve chamber 101, one moving chamber 102, one oil storage chamber 103, and one oil return passage 104. The valve chamber 101 is located in the middle of the oil return passage 104 and communicated with the oil return passage 104. The two ends of the oil return passage 104 are respectively connected to the oil storage chamber 103 and the moving chamber 102. The oil pump main body 10 is hinged with a pump lever 2 through a shaft pin 8.

In this embodiment, referring to FIG. 1-FIG. 2, the moving chamber 102 is provided with an oil pump core 109 and a oil cylinder chamber 106. The oil cylinder chamber 106 is provided with a lifting component 108 for driving oil pressure. The improved oil release mechanism further includes an oil drain valve 3, a rotation shaft 4, and a transmission component 5.

The oil drain valve 3 is located inside valve chamber 101 and has a driving part 301 extending to the outside of valve chamber 101; the oil return passage passes through the valve chamber 101, and the two ends of the oil return passage are communicated with the oil storage chamber and the oil cylinder chamber of the oil cylinder.

The rotation shaft 4 is axially arranged in the inner cavity of the pump lever 2 and rotationally positioned with the pump lever 2.

The transmission component 5 is used to transmit the power of to shaft 4 for driving the opening and closing of the oil drain valve 3. The transmission component 5 includes a first gear 501, a universal joint 502 and a second gear 503. The first gear 501 is rotatably arranged on a base formed on one side of the oil pump main body 10. The two ends of the universal joint 502 respectively connected to the first gear 501 and the first end of the rotation shaft 4. The second gear 503 is coaxially arranged with the driving part and meshes with the first gear 501.

The rotating axis of the first gear 501 and the rotating axis of the second gear 503 have an angle of 45° to 60°, preferably 45° or 60°. This angle can ensure stable meshing between the first gear and the second gear to ensure the stability of gear transmission.

In the technical solution of the above embodiment, during use, the rotational force of the rotation shaft 4 is transmitted by the universal joint 502, which drives the first gear 501 to drive the second gear 502 to rotate. The second gear 502 is connected to the driving part 301, thereby controlling the working state of the oil drain valve 3.

Continuing to refer to FIG. 1-FIG. 3, the universal joint 502 is a cross universal joint, and the center of the universal joint 502 is located on the rotating axis of the pump lever 2. The universal joint 502 includes a first joint fork 521, a second join fork 522, and a cross shaft 523. The first joint fork 521 is coaxially fixed and assembled with the rotation shaft 4; the second join fork 522 is coaxially fixed and assembled with the first gear 501; and the cross shaft 523 is arranged between the first join fork 521 and the second join fork 522 to relay the transmission of the first join fork 521 and the second join fork 522, and the center of the cross shaft 523 is located on the rotating axis of the pump lever 2.

In the technical solution of the above embodiment, the rotational transmission between the rotation shaft 4 and the second gear 503 is achieved through the universal joint 502. The universal joint 502 can achieve variable angle power transmission, and this setting can ensure that the cross universal joint can stably and efficiently transmit power or change angle during the rotation of the pump lever 2, ensuring the smoothness and stability of the operation of the lightweight jack. It can be understood that when the pump lever 2 swings up and down, it drives the movement of the first join fork 521, but the second join fork 522 remains stationary, and the positions of the first gear 501 and the second gear 503 remain relatively fixed, effectively improving the transmission stability.

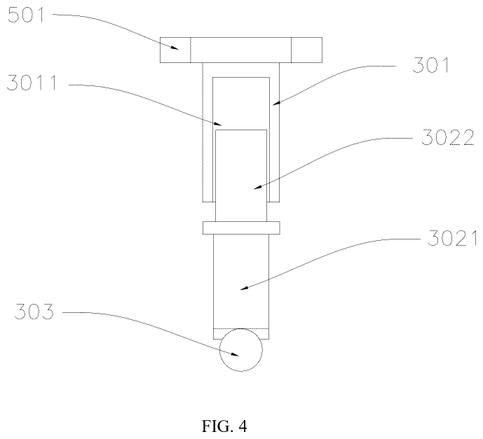

FIG. 4 is a structural schematic diagram of the combination of the oil drain valve and the first gear according to an exemplary embodiment. Referring to FIG. 1-FIG. 4, in this embodiment, the oil drain valve 3 includes a driving part 301, a valve stem 302, and a steel ball 303.

The first end of the driving part 301 is coaxially fixed and assembled with the second gear 503, and the second end of the driving part 301 is axially positioned inside the valve chamber 101 and rotatably assembled with the inner chamber of the valve chamber 101.

The valve stem 302 has a first stem portion 3021 and a second stem portion 3022. The first stem portion 3021 is threaded to the inner wall of the valve chamber 101, and the second stem portion 3022 extends to the outside of the valve chamber 101 and is axially movable connected to the second end of the driving part 301. The free end section of the second stem portion 3022 is a non-circular structure, and a positioning hole 3011 matched with the second stem portion 3022 is formed axially on the second end of the driving part 301. It can be understood that the positioning hole 3011 can be formed as a non-circular structure such as rectangular, polygonal, elliptical, etc. The function of the positioning hole 3011 is to enable the valve stem 302 to rotate synchronously with the driving of the driving part 301 and the axial movement of the valve stem 302 is not limited.

The steel ball 303 is movably arranged in the valve chamber 101 and located at the free end of the first stem portion 3021. The diameter of the steel ball 303 is larger than the diameter of the oil return passage 104 to block the oil return passage 104 when it is pushed against by the valve stem 302.

Continuing to refer to FIG. 2, the oil drain valve 3 further includes a handle 7. The handle 7 has a insertion portion 701 that can be freely assembled at the free end of the pump lever 2. A rotary mating groove 702 is formed at the free end of the insertion portion 701, and the second end of the rotation shaft 4 is formed with a rotary mating head 201 that matches and engages with the rotary mating groove 702; at least one locking bolt 6 is threadedly assembled at the position corresponding to the insertion portion 701 of the pump lever 2, and the bolt tail of the locking bolt 6 extends into the annular groove 703 formed on the insertion portion 701 to lock and assemble the pump lever 2 and the handle 7.

In this embodiment, the front end of the pump lever 2 is movably hinged to the oil pump main body 10, and the handle 7 is inserted into the rear end of the pump lever 2, and then locked and fixed with the annular groove formed on the handle 7 through the locking bolt 6. Therefore, when the handle 7 is axially connected to the pump lever 2, the handle 7 can still rotate around its own axis. The pump lever 2 can drive the oil pump core 109 in the moving chamber 102 to move by operating handle 7, and drive the oil in the oil storage chamber 103 to reach the oil cylinder chamber 106 through the connected oil inlet passage 107 and the one way valve 105 which allows oil inlet along one-way direction, and then driving the lifting component to extend from the oil cylinder chamber 106 to lift heavy objects. At the same time, a plug-in fit is formed between the handle 7 and the shaft 4. Turning the handle 7 can sequentially drive the rotation of the shaft 4, the first gear 501, and the second gear 503, thereby opening or closing the oil drain valve 3.

In the technical solution of the above embodiment, combined with FIG. 1-FIG. 2, under normal conditions, the valve stem 302 is pressed down against the steel ball 303, and the oil return passage 104 is blocked and disconnected by the steel ball 303. When lifting, the handle 7 is operated to swing up and down, and the hydraulic medium in the oil storage chamber 103 can only enter the oil cylinder chamber 106 through the oil inlet passage 107 and the one-way valve 105 which allows oil inlet along one-way direction, driving the lifting component to extend from the oil cylinder chamber 106 to lift the heavy object. On the contrary, when the pressure is relieved, the handle 7 is rotated in the opposite direction, and the rotational force of the rotation shaft 4 drives the driving part 301 to rotate in the valve chamber 101 through the relay transmission of the transmission component 5. Due to the axial movement and limited rotation direction of the valve stem 302 and the driving part 301, the valve stem 302 moves upward under the cooperation of the threads, releasing the steel ball 303, opening the oil return passage 104, and the hydraulic medium in the oil cylinder chamber 106 returns to the oil storage chamber 103 through the oil return passage 104 under pressure, so that the jack is reset.

In an alternative embodiment (not shown in the figure), the side wall of the second stem portion 3022 has at least one axially extending key portion, and the second end of the driving part 301 is axially provided with a moving hole that matches the second stem portion 3022, and the axial side wall of the moving hole is provided with at least one key slot that matches the key portion.

In another alternative embodiment (not shown in the figure), the second end of the driving part 301 has an extension portion, and the annular side wall of the extension portion has at least one axially extending key portion. The free end of the second stem portion 3022 is axially provided with a moving hole that matches the second stem portion 3022, and the axial side wall of the moving hole is provided with at least one key slot that matches the key portion.

In the technical solutions of the above two optional embodiments, only the specific axial movable connection structure between the valve stem 302 and the driving part 301 is changed, and it will not affect the overall implementation of the solution, with the same effect, as an optional alternative solution.

### Embodiment 2

The difference between this embodiment and embodiment 1 is that embodiment 2 of the present disclosure provides a lightweight jack. As shown in FIG. 1, it includes the improved oil release mechanism of the above embodiment 1.

In the technical solution of the above embodiment, the method of using the improved oil release mechanism of the lightweight jack is as follows:
S1, Align the handle 7 with the rear end of the pump lever 2 and insert the handle 7 into the rear end of the pump lever 2; tighten the locking bolt 6 for axial positioning;
subsequently, by swinging the handle 7 up and down, the lifting operation of the heavy object can be easily achieved;

S2, After the lifting is completed, rotate the handle 7, and the power generated will be transmitted along the rotation shaft 4; the direction of force transmission will be changed through the transmission component 5, and the power will be transmitted to the oil drain valve 3, so as to open the oil drain valve 3 to achieve the pressure relief operation; the pressure relief process is completed, and the jack is reset;

S3, Rotate the handle 7 in reverse to close the oil drain valve 3, preparing for the next lifting of heavy objects.

Other structures not described refer to Embodiment 1.

In summary, the improved oil release mechanism of the lightweight jack provided in the embodiments of the present disclosure allows users to easily perform pressure relief operations by simply turning the handle 7, without the need to separate the handle from the pump lever, greatly simplifying the operation process and providing users with a convenient user experience. At the same time, the pump lever 2 is hinged on the oil pump body 1 without the need for wall panels, making the structure more compact and reducing the overall volume of the lightweight jack. Furthermore, the improved oil release mechanism eliminates the dynamic meshing state between the first gear 501 and the second gear 503, ensuring the reliability of product operation and significantly extending its service life.

What is claimed is:

1. An improved oil release mechanism for a lightweight jack, comprises an oil pump body, wherein the oil pump body is provided with at least one valve chamber, one moving chamber, one oil storage chamber, and one oil return passage; the valve chamber is located in a middle of the oil return passage and is connected to the oil return passage; two ends of the oil return passage are respectively connected to the oil storage chamber and the moving chamber; and a main body of the oil pump is hinged with a pump lever;
an oil drain valve, set inside the valve chamber and provided with a driving part extending to an outside of the valve chamber;
a rotation shaft, axially set in an inner chamber of the pump lever and positioned with the pump lever for rotation; and
a transmission component, configured to transmit power of the rotation shaft to drive an opening and closing of the oil drain valve, wherein the transmission component comprises a first gear rotatably assembled on a base formed on one side of the oil pump body; an universal joint, with its two ends respectively connected to the first gear and a first end of the rotation shaft; and a second gear coaxially arranged with the driving part and meshed with the first gear.

2. The improved oil release mechanism according to claim 1, wherein an angle is formed between a rotation axis of the first gear and a rotation axis of the second gear, and a range of the angle is 45°-60°.

3. The improved oil release mechanism according to claim 1, wherein the universal joint is a cross universal joint, and a center of the universal joint is located on a rotation axis of the pump lever.

4. The improved oil release mechanism according to claim 1, wherein the universal joint comprises:
a first fork, coaxially fixed and assembled with the rotation shaft;
a second fork, coaxially fixed and assembled with the first gear; and
a cross shaft, set between the first fork and the second fork to relay a transmission of the first fork and the second fork.

5. The improved oil release mechanism according to claim 1, wherein the oil drain valve comprises:
a driving part, comprising a first end coaxially fixed and assembled with the second gear, and a second end axially positioned in the valve chamber and rotatably assembled with an inner chamber of the valve chamber;
a valve stem, comprising a first stem portion and a second stem portion, wherein the first stem portion is threaded to an inner wall of the valve chamber, and the second stem portion extends to the outside of the valve chamber and is axially movable connected to a second end of the driving part; and
a steel ball, movably set within the valve chamber and located at a free end of the first stem portion, wherein a diameter of the steel ball is greater than a diameter of the oil return passage to block the oil return passage when the steel ball pushed against by the valve stem.

6. The improved oil release mechanism according to claim 5, wherein a section of a free end of the second stem portion is a non-circular structure, and a second end of the driving part is axially provided with a non-circular positioning hole that matches the second stem portion.

7. The improved oil release mechanism according to claim 1, wherein the handle is provided with a insertion portion assembled with a free end of the pump lever, and a free end of the insertion portion is provided with a rotary mating groove, and a second end of the rotation shaft is formed with a rotary mating head that matches the rotary mating groove.

8. The improved oil release mechanism according to claim 1, wherein at least one locking bolt is threaded at a position corresponding to the plug-in portion of the pump lever, and a tail of the locking bolt extends into the annular groove opened on the plug-in portion to lock an assembly of the pump lever and handle.
